(19) United States
(12) Patent Application Publication
(10) Pub. No.: US 2003/0168508 A1
(43) Pub. Date: Sep. 11, 2003

(54) Money handling device having universal interface board

(76) Inventors: Francisco X. Robles Gil Daellenbach, Edo. Mex (MX); Jacek Oktaba, Mixico City (MX); Keith Henriksen, Plymouth, MN (US)

Correspondence Address: FREDRIKSON & BYRON, P.A., 4000 PILLSBURY CENTER, 200 SOUTH SIXTH STREET, MINNEAPOLIS, MN, 55402, US

(21) Appl. No.: 10/095,332

(22) Filed: Mar. 11, 2002

Related U.S. Application Data
(60) Provisional application No. 60/274,756, filed on Mar. 9, 2001.

(51) Int. Cl. G06F 17/60

(52) U.S. Cl. 235/379

(57) ABSTRACT

A money handling kiosk or appliance including an interface device coupled to a general purpose computer and at least one money handling peripheral device. The money handling kiosk preferably includes a secure housing disposed about the interface board or device and money handling peripheral devices. One money handling appliance includes a general purpose computer having a display screen and a touch input screen as well as a bar code reader and a magnetic strip reader. The kiosk can further have at least one bill validator and one coin validator. The interface device can be coupled to, and communicate with, several brands or models of money handling peripheral devices of the same type. The interface device can act to encapsulate the functionality of the various money handling peripheral devices. The interface device can accept commands from the general purpose computer and return data to the general purpose computer in the same format, regardless of the model of money handling peripheral device currently coupled to the interface device. The general purpose computer can thus issue commands to, and receive data from, virtual money handling peripheral devices using the same software for differing models of similar devices. The kiosk allows the use of off-the-shelf personal computers and off-the-shelf money handling peripheral devices coupled through the interface device to create money handling appliances. The lower priced appliance allows entry into new low cost applications for the intelligent money handling kiosk. In one use, gasoline station attendants are able to deposit currency into an armored kiosk, receiving an accurate accounting of their deposit almost immediately. In another use, the kiosks may be placed in numerous locations for accepting payment of utility and cellular phone bills.

### RELATED APPLICATION

The present invention is related to and claims priority to U.S. Provisional Patent Application Serial No. 60/274,756, entitled UNIVERSAL PERIPHERAL EXPANDER FOR AUTOMATIC TELLER MACHINES AND BILL PAYING KIOSK, herein incorporated by reference in entirety.

### FIELD OF THE INVENTION

The present invention is related generally to money handling devices. More specifically, the present invention is related to money handling kiosk devices having an interface board interfacing general purpose computers to money handling peripheral devices.

### BACKGROUND OF THE INVENTION

Automatic Teller Machines (ATMs) and bill paying kiosks are well known devices. ATMs are common throughout the world. Bill paying kiosks are less well known, being present in the world and North America generally, and in Latin America in particular. Many countries in the Americas have a hybrid economy, including a substantial cash economic component and a substantial modern, electronic component. In these hybrid economies, consumers often pay for goods and services using cash. The cash payments are often deposited, and the deposited amount wired to pay for, for example, utility bills, cable television bills, and cellular telephone bills. Consumers in the hybrid economies have the advantages and privacy of using readily available cash while have the advantages of on-line bill paying. Mexico is one such American country having such a hybrid economy, making frequent use of bill paying kiosks.

ATMs and bill paying kiosks commonly use a computer driven user interface device coupled to money handling peripherals, for example, bill validators and coin acceptors or validators. The bill validators typically receive, validate, and count paper currency fed into the bill validators. The coin acceptors typically perform a similar function for coins. ATMs are typically sufficiently expensive so as to preclude or limit their use in certain applications. Bill paying kiosks as well have often priced themselves out of markets they might otherwise be acceptable in. The expensive nature of the bill paying kiosks is due in large part to the proprietary nature of their design. A typical bill paying kiosk has a user interface computer device coupled to the money handling peripherals. The bill paying kiosks typically have a proprietary computer board which can drive both the user interface display and user input devices as well as the money handling peripherals. The use of proprietary hardware boards has been common for several reasons. The proprietary boards often originated prior to personal computers being as commonplace as they are today. The proprietary circuit boards can also be electrically coupled to a wide variety of devices. The proprietary boards also offer enhanced security over personal computers. The proprietary boards often have a more robust operating system or kernel, relative to the often unreliable operating systems typical on personal computers. While this unreliability can be accepted in some user interface functions, the unreliability is unacceptable for the money handling aspects of the bill paying devices. For these reasons, personal computers have often been not designed into bill paying kiosks and automatic teller machines.

Personal computers have been used to communicate to some money handling devices, in unique, niche applications. In one such an application, a single money handling device may be directly coupled to, for example, a serial port on a personal computer. The personal computer may run software specified by or supplied by the money handling peripheral manufacturer. The software drivers used in such niche applications is only as reliable as the personal computer operating system. The drivers must also be updated continuously as the personal computer operating system vendors change operating systems. The security of personal computers is weak, leaving the money handling peripherals subject to the weaknesses of personal computer bugs, viruses, and security holes, well known to those skilled in the computer arts. Personal computers are also unable to provide or read the required electrical signals needed from some money handling peripherals. Some peripherals require discrete I/O voltages of 24 VDC or even 110VAC.

One application which could benefit from an automatic teller machine or bill paying kiosk type of device is the convenience store or gasoline station money deposit device. In convenience stores, for example, stores open 24 hours per day, the clerks accept currency and periodically deposit the currency into a safe to reduce the amount of currency on hand to lessen the danger and loss of money, which can result from armed robberies. The money is typically bundled together and dropped through a floor safe.

Gasoline or petrol stations in many American countries allow customers to purchase gasoline or petrol with currency, which is given to attendants staffing the service station. The attendants are sometimes paid on commission as a percentage of the money they take in from the customers. The attendants currently bundle the currency together, write their name on a piece of paper, fix the piece of paper to the bundle of currency, and put the currency into a safe on the service station premises, for example, a “spin safe.” The managers or owners of the service stations, or guards of an armored care company acting on behalf of the owners, will open the safe, remove the bundles of cash with the associated paper slips, to be counted later.

In the gasoline station example, the service attendants often believe that the station owners undercount the money submitted, not giving the attendants full credit for the money turned in. Likewise, the gasoline station owners often believe the attendants are withholding money, and not turning in the fall amount. The spin safe system does not allow for an accurate accounting of the money turned in that is suitable to either party.

What would be desirable is a money handling kiosk device having a sufficiently low cost so as to be usable in a greater number of applications. What would also be desirable is a device made from inexpensive personal computers and money handling peripherals available off-the-shelf from a large number of providers.

### SUMMARY OF THE INVENTION

The present invention includes an automatic money handling kiosk device or appliance including an interface device coupled to a general purpose computer and also coupled to at least one money handling peripheral device. The money handling appliance can further include an armored housing disposed about the personal computer, interface device, and money handling peripherals to provide security for the devices. The present invention allows off-the-shelf personal computers and off-the-shelf money handling peripherals to be bought together within the kiosk and coupled to each other through the interface device board provided by the present invention. The interface board thus provides significant economies of scale, and provides transparency for the different money handling peripheral devices, by encapsulating the control in the interface device.

The configuration of the money handling appliance according to the present invention may of course vary according to its intended use. In some bill paying or store deposit applications, only money accepting peripherals may be provided. In some retail deposit devices however, some bill dispensers will also be included to allow amount and time limited dispensing of paper currency for the purposes of making change. Some devices may further have magnetic card readers for reading employee or user ID cards as well as bar code readers for reading the bar codes on paper strips such as consumer bills held up to the bar code reader.

The present invention includes one embodiment of an interface device in a circuit board designed according to the present invention. In some embodiments of the invention, commercially available but suitable boards may also be used. Interface boards useful with the present invention can include a microprocessor, memory for storing data and programs for executing in the microprocessor, a non-volatile memory for persistently storing data, as well as at least one communication port for communicating to the general purpose computer and at least one communication port for communicating to a money handling peripheral. Preferred embodiments according to the present invention include a serial data communication port for communicating to the general purpose computer, several serial communication ports for communicating to money handling peripherals, as well as several parallel or discrete I/O ports for communicating to other money handling peripheral devices. One embodiment of the present invention includes flash (EEPROM) for storing security information and data useful in the present invention.

A money handling device according to the present invention may be set up or configured by coupling the money handling peripherals to the communication ports on the interface device, and coupling the general purpose computer to a communication port on the interface device. Software drivers appropriate for the money handling peripherals are preferably stored in the general purpose computer in non-volatile storage. Drivers may be provided for communicating to a variety of classes or types of money handling peripheral devices. A money handling device class or type may be considered to be a group of money handling peripheral devices which perform essentially the same function. One example of a type money handling device is a group of bill validators, each made by a different manufacturer. Within each type of money handling peripheral device, the different devices may be considered to each have a different instance, make, model number or model. The general purpose computer may thus store the drivers for several models of each type of money handling peripheral device. In a set up or initialization procedure, the appropriate driver for the model of money handling device coupled to the interface board may be downloaded from the general purpose computer into the interface device. Each money handling device coupled to the interface board can have a software driver loaded into the board to communicate to the money handling peripheral through the appropriate interface device port. In some embodiments, the drivers for more than one money handling peripheral device are resident on the board at any one time, with only one such driver being active per model of money handling peripheral device.

The software drivers resident on the interface device are preferably written to run on that interface device rather than on a general purpose computer. In one example, the executable code residing and running on the interface device is machine code appropriate for that interface device, rather than code capable of being executed on the personal computer or general purpose computer on which the code may have originally been stored.

With the appropriate drivers resident on the interface board, operation of the money handling device or kiosk is now possible. In a preferred embodiment of the invention, the general purpose computer sends a similar, preferably identical, message to the interface board to accomplish the desired result, regardless of the model of money handling peripheral device currently coupled to the interface board. Thus, a request from the general purpose computer to the interface device to dispense one denomination of paper currency will be the same regardless of the model of paper currency dispenser currently coupled to the interface board. In another example, the same or similar command will be sent from the general purpose computer to the interface device when the bill validator is to be enabled to begin counting paper currency fed into the paper currency validator. In yet another example, the message sent from the interface device to the general purpose computer will be the same or similar regardless of the model of currency or coin accepter that is providing the input currency information from the coin or currency validator to the interface board.

While the general purpose computer is preferably aware of the actual model of money handling interface device for maintenance purposes, the commands sent to the interface device and the replies received from the interface device are preferably independent of the model of money handling peripheral device coupled to the interface board. The software executing on the general purpose computer for providing the user interface is preferably the same for all money handling peripheral device models coupled to the interface device. The general purpose computer can be viewed as sending messages to, and receiving messages from, a virtual money handling device having a specific type. The type can be bill validator, coin validator, bill dispenser, coin dispenser, and others. The logic to receive the message, unpack the message, and format new messages, bit vectors or logic to control the specific model of money handling device are affectively encapsulated in the interface device.

In one use of the present invention, a gasoline station attendant or retail store employee swipes his identification card bar code across the kiosk bar code reader, and is presented with a menu on a display screen of the general purpose computer. The employee can then interact with the general purpose computer through a user input device, which can be a touch screen coupled to the general purpose computer. The employee may indicate that the deposit of money in the form of paper currency and coin is desired, and the general purpose computer may then enable the bill validator and the coin validator through a message requesting that the bill validator and coin validator each be enabled. This message is preferably the same message regardless of the model of bill and coin validators currently coupled to the interface device. The enable messages are sent to the interface device, which then executes the model-specific code to enable each appropriate money handling interface device.

As the employee feeds bills and/or coins into the appropriate receptacle in the kiosk, the money handling peripheral devices count the bills and coins fed into the kiosk. As the currency is validated and counted, the interface device is informed of the currency amounts being counted. The currency is validated and accepted by the money handling peripheral device, which signals the successful acceptance of each currency item and transmits this information to the interface device through the appropriate port. Each model of money handling peripheral device may have its own format for transmitting the data to the interface device. The interface device can then convert the data received from the money handling peripheral device into a common, universal format which is independent of the brand and model of the money handling peripheral device. Thus, the acceptance of a given paper currency denomination will be reported from the interface device to the general purpose computer in the same format, regardless of the brand or model of bill validator currently coupled to the interface device. In a preferred embodiment, each currency item accepted is reported to the general purpose computer, which responsible for the totalizing.

After the session is complete, the general purpose computer can send a message to the interface device to print a receipt and to store the transaction information for the given employee number. The interface device can then store the transaction information in non-volatile memory and use the currently resident printer driver to print out a receipt for the employee on the connected printer.

The transaction information may be stored internally within the kiosk as well as made available to management outside of the kiosk. In some kiosks, information can be transmitted via a hard wired LAN or a wireless cellular connection periodically established by the kiosk to report the transaction information. At periodic intervals, in some methods, a guard from an armored car company will unlock the kiosk, remove the cassettes or hoppers containing currency fed into the kiosk by the service station employee. The gasoline station attendant or retail store employee thus has a paper receipt indicating an accurate accounting of the money deposited into the kiosk, while the managers also have an accurate accounting of the currency fed into the kiosk.

New models or brands of money handling peripheral devices may periodically be used to replace older devices in the kiosk. Lower priced money handling peripheral devices may be used to replace higher priced or less reliable devices. When a new money handling peripheral device is coupled to the interface device, the appropriate driver for that money handling peripheral device can be loaded into the general purpose computer, then downloaded into the interface device to execute subsequent commands from the general purpose computer and to report data from the money handling peripheral device to the general purpose computer. In an alternate embodiment, the driver is loaded by a technician directly into the interface board, through a patch cable or communication port and a driver loading utility.

One device according to the present invention is an automatic teller machine (ATM). The ATM can have a general purpose computer coupled through a communication port to an interface board. The interface board can be coupled to a card reader and a bill dispenser, with some ATMs also having a bill validator and a bar code reader. The general purpose computer can be coupled through a communication port to a LAN, a WAN, a modem, or other device for communicating to another computer. The general purpose computer can run ATM graphical user interface (GUI) software, familiar to those using ATMs and well known to those skilled in the art. The ATM GUI can prompt the user to swipe an optically or magnetically coded card, and to select from query, transfer, deposit, and withdrawal options. After accepting the user data, ID and request, the general purpose computer can forward the data, request, and ID to a trusted third party intermediary for handling. The trusted third parties presently exist, are common, and presently service requests from many independently owned ATMs. The trusted third party then executes software to communicate with a bank to make the query, transfer, deposit, or withdrawal from the user's account. The bank computer can then send the appropriate response to the trusted third party for relaying to the ATM. A similar system may be used with bill paying kiosks in dealing with utilities for bill paying.

### DESCRIPTION OF THE DRAWINGS

FIG. 1A is a perspective view of a money handling appliance or kiosk, having the doors closed;

FIG. 1B is a perspective view of the money handling appliance or kiosk of FIG. 1A, having the lower outer door open;

Figure 1C is a perspective view of the money handling appliance or kiosk of FIG. 1A, shown with the lower, inner door and upper door open;

FIG. 2 is a block diagram of a money handling appliance or kiosk according to the present invention, having an interface device or board providing communication between a general purpose computer and numerous money handling peripheral devices;

FIG. 3 is a diagram of a message format used to communicate between the interface board and general purpose computer of FIG. 2; and

FIG. 4 is a highly schematic drawing of one interface device processor board.

### DETAILED DESCRIPTION OF THE PREFERRED EMBODIMENTS

The following detailed description should be read with reference to the drawings, in which like elements in different drawings are numbered identically. The drawings, which are not necessarily to scale, depict selected embodiments and are not intended to limit the scope of the invention. Several forms of invention have been shown and described, and other forms will now be apparent to those skilled in art. It will be understood that embodiments shown in drawings and described above are merely for illustrative purposes, and are not intended to limit scope of the invention as defined in the claims which follow.

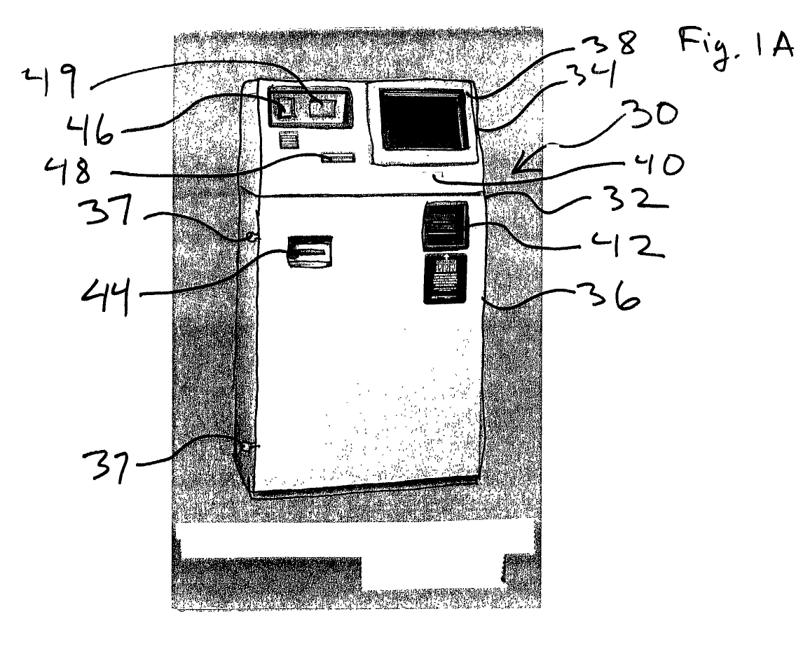

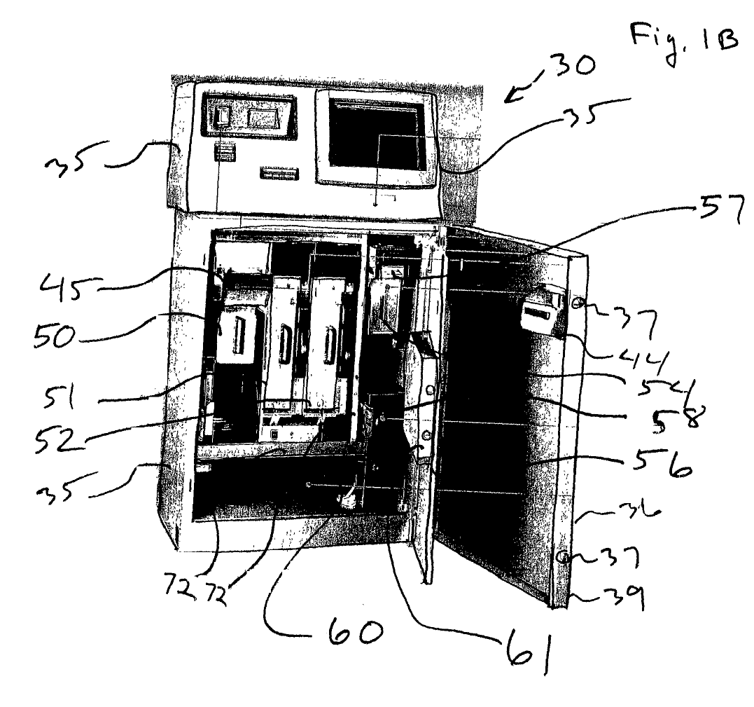

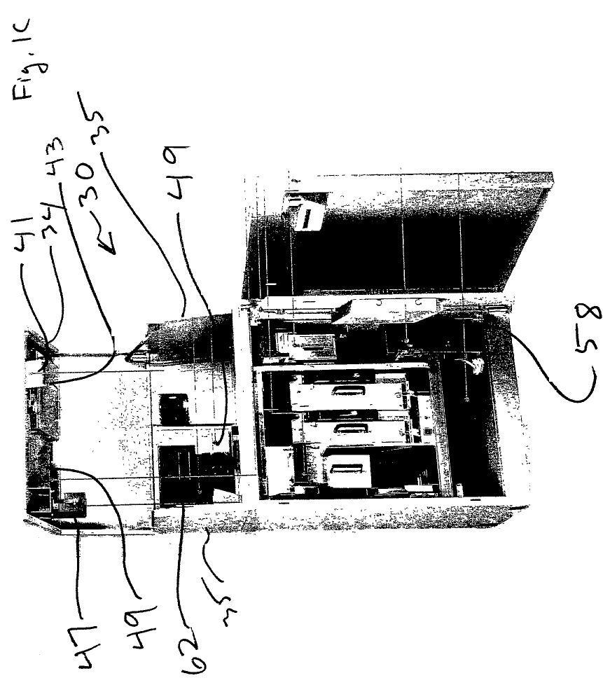

FIG. 1 illustrates an automated money handling kiosk device or appliance 30 including generally an enclosure 32, having a top portion 34 and a bottom portion 36. Both top portion 34 and bottom portion 36 may be opened to access the internals of kiosk device 30. Bottom portion 36 may be opened and secured through use of locks 37. Enclosure 32 generally is constructed of, or can be constructed of, heavy gage steel, with one embodiment being formed of a 14 gauge cold rolled steel outer shell and a 10 gauge steel interior to provide security.

Kiosk 30 includes a user interface device which can be either video and/or audio depending on the embodiment. In the embodiment illustrated, the user interface device is a display screen 34 which is coupled to a general purpose computer (not illustrated in FIG. 1A). In a preferred embodiment of the invention, display device 34 includes a touch screen portion, which forms the user data input device for kiosk 30. Audio input/output devices are explicitly within the scope of the present invention. The enclosure 32 has numerous apertures to access money handling peripheral devices disposed within the enclosure, as well as other intelligent devices disposed within or near the surface of the enclosure.

A bar code scanner aperture 40 may be seen in enclosure upper portion 34. The bar code scanner 40 may be used to read bar coded employee numbers as well as bill bar codes. A printer aperture 48 may be seen, for issuing receipts and other printed material. A coin accepter or deposit aperture 46 may be seen for accepting coin deposits by the users. A bar code reader or a magnetic code reader 49 may be included for reading the bar codes, smart cards, or magnetic stripes on identification cards. A bill or paper currency validator aperture 42 may be included, for accepting and validating paper currency deposits therethrough. A bill or paper currency dispenser aperture 44 may also be seen in kiosk 30, for issuing paper currency to users. Kiosk 30 may also have other apertures allowing connection between the general purpose computer and the outside world through LAN connections, WAN connections, modems, wireless, and cellular communication antennas.

FIG. 1B illustrates kiosk 30 having lower portion 36 open. Lower portion 36 may be seen to include a pivotally mounted door 39 carrying locks 37 previously described. Bill dispenser aperture 44 may be seen as well as bill dispenser 45. Bill dispenser 45 is disposed near a cassette or hopper 50. Bill dispenser 45 is also disposed near a first cassette 51 and a second cassette 52, each for holding a different denomination of paper currency for dispensing through bill dispenser 45. The bill dispenser and associated hoppers and cassettes may be provided as a single unit, mounted in a rack 72 formed by rails carrying the bill dispenser, hopper, and cassettes. In one embodiment, the bill dispenser is a DeLarue brand dispenser.

A bill or paper currency validator 57 may also be seen. In one embodiment, the bill validator is a JCM model bill validator. The bill validator, as the term in used herein, refers to a device that can check for the validity of paper currency inserted into the bill validator and that reports out the occurrences of valid currencies being accepted by the bill validator. A cassette 54 may be seen coupled to bill validator 57 for receiving the paper currency inserted through the bill validator.

An inner security door 56 may also be seen, providing added security through the presence of added locks 61. In one embodiment, inner door 57 is formed of nominally ⅜ inch stainless steel, providing a Category 3 safe. Sidewalls 35 may also be seen, forming part of the enclosures. An interface device or interface board 58 may also be seen within kiosk 30, to be discussed later. A power supply 60 may also be disposed near interface device 58.

FIG. 1C illustrates kiosk 30 having upper portion 34 opened about a back hinge. A general purpose computer 43 may be seen disposed behind user interface display 38, previously discussed. In one embodiment of the present invention, the general purpose computer is an NCR model 7401 computer. As used herein, the term, “general purpose computer” refers to a computer not specifically intended for use with money handling peripheral devices. Such a general purpose computer generally has a user interface portion as well as a communication port. Some general purpose computers are personal computers while others are general purpose imbedded PC computers.

A coin hopper 62 may be seen for receiving coins inserted through a coin acceptor or coin validator 47. A printer 49 may be seen disposed near printer aperture 48, previously discussed. A magnetic card or intelligent card reader 49 may be seen as previously discussed, shown from the inside. A bar code scanner 41 may be seen disposed near bar code aperture 40, previously discussed. As will be discussed further, interface device 58 is coupled to the bill validator, coin validator, bill dispenser, coin dispensers, and other money handling peripheral devices. In the embodiment illustrated, interface device 58 is also coupled to the bar code reader, the printer, and the magnetic card or intelligent card reader. In some embodiments, general purpose computer 39 is also coupled to a modem and/or network interface line to communicate with other devices.

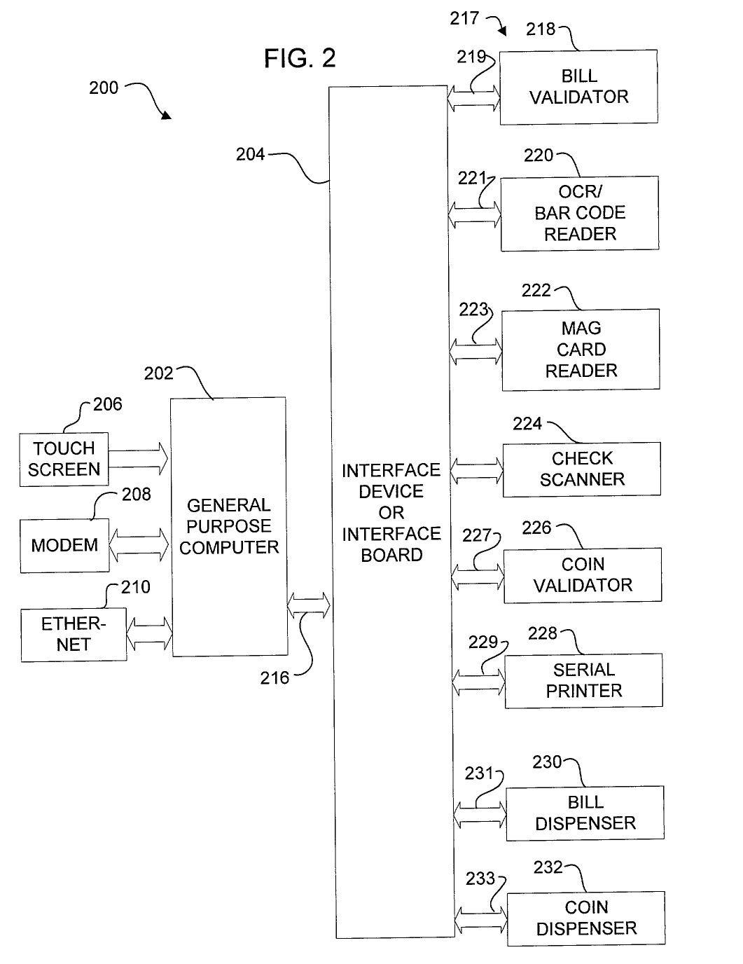

FIG. 2 is a block diagram of an automated money handling system or appliance 200. Money handling system 200 includes a general purpose computer 202, an interface device or interface board 204, and numerous money handling peripheral devices 217. General purpose computer 202 may be coupled to a touch screen 206 or other user interface device. In one embodiment, touch screen 206 forms both the user display device and the user data input device. The general purpose computer 202 may thus give information to the user through the display portion of the touch screen, and, by providing menus to the display, accept data input from the user. A modem 208 may also be provided for communicating with computers outside of and remote to system 200. An Ethernet or other data communication network line 210 may also be coupled to general purpose computer 202. General purpose computer 202 includes a communication port 216 used to communicate to interface device 204. In a preferred embodiment, communication port 202 is a serial, v.24 communication port.

Interface device 204 can be any interface device capable of executing the software of the present invention and capable of electronically communicating with the special money handling peripheral devices well known to those skilled in the art. In one embodiment of the present invention, interface device 204 is a single circuit board having an Intel 8051 microprocessor which is coupled to memory for storing the programs executed by the processor as well as data. The interface device further includes, or can include, non-volatile memory, for example, flash memory for persistently storing data. In one embodiment of the invention, to be discussed later, interface device 204 includes numerous serial and parallel ports adapted to communicate with various money handling peripheral devices and other devices. With respect to interface device 204, communication port 216 may be referred to as a primary communication port for communicating to the general purpose computer, and the communication ports used to communicate with the various money handling peripheral devices may be referred to as secondary communication ports.

In the embodiment illustrated, system 200 includes a bill validator 218 coupled to interface device 204 through communication channel 219. In some embodiments of the invention, bill validator 218 can be a JCM model WBA ID-003, or a Cash Code model CCRS232-02 bill validator.

An optical character reader or bar code reader 220 may be seen coupled through a secondary communication port 221 to interface device 204. A magnetic card reader 222 may also be seen coupled through communication port 223 to interface device 204. A check scanner 224 is coupled to interface device 204.

A coin validator 226 may be seen coupled through communication port 227 to interface device 204. In one embodiment of the invention, coin validator or acceptor 226 is a model CC435. A serial printer 228 is coupled through a communication port 229 to interface device 204. A bill dispenser 230 may also be seen coupled through communication port 231 to interface device 204. In one embodiment of the invention, bill dispenser 230 is a DeLarue bill dispenser, model no. MDDM-300. A coin dispenser 232 may be seen coupled to interface device 204 through communication channel or port 233.

The various money handling peripheral devices having the same or essentially the same functionality are herein defined to be the same “type” of money handling peripheral device. The different money handling peripheral devices within the same money handling peripheral device type are herein defined to be different “models” of money handling peripheral devices of the same type. Money handling peripheral device types include bill validators, coin validators, bill dispensers, and coin dispensers. The different models of bill validators, for example, may be provided by the same or different manufacturers and have different model numbers. It is expected that the different models of money handling peripheral devices may have different electrical and logical requirements for communicating to interface device 58. Some may require serial communication, through an RS 232 connection, while others require parallel or discreet I/O communication, at different voltages, on a bit by bit level with interface device 204.

In a typical use of system 200, a user will interact with touch screen 206, with user interface software executing in general purpose computer 202, and a command being issued in response through primary communication port 216 to interface device 204. Logic or computer software modules within interface device 204 can then transform or translate the command received from primary port 216 into the appropriate logic or signals to communicate or operate the specified money handling peripheral device 217. In one example of the invention, after suitable user interface logic and checking, general purpose computer 202 may instruct a virtual bill dispenser on interface board 204 to dispense a $20 bill. This instruction to dispense a $20 bill will be issued to the interface board through primary communication port 216, in a common command language, independent of the model of bill dispenser currently coupled to interface device 204. The appropriate software module residing and executing within interface device 204 can then execute the appropriate logic in the software to control and communicate with actual bill dispenser 218 through communication port 231. In one example, port 231 is a serial communication port, with the message sent from interface device 204 to bill dispenser 218 being a serial message having the instruction to dispense the $20 bill being encoded in the message. In some embodiments, the message will be formatted as an instruction to dispense a number of bills from a given number hopper. In other examples of the invention, port 231 may be a parallel port, with some bits of the parallel port having commands asserted within single bits of the port while other bits have binary or BCD encoded data included in a grouping of bits.

Continuing with the bill dispensing example, after appropriate error checking, bill dispenser 230 can communicate through port 231 to interface device 204 that the $20 bill has been successfully dispensed. This information is transmitted through port 231 in a format most likely proprietary to bill dispenser 230, and being different from other model bill dispensers. The appropriate software module executing in interface device 204 can interpret, format, and translate the data received through port 231 and convert this data received into a common data format for reporting to general purpose computer 202 through primary communication port 216. In this example, the common message format may report that a $20 bill has been dispensed through a bill dispenser, where that message has the same format regardless of the model of bill dispenser currently coupled to interface device 204. The interface board can thus act as a virtual bill dispenser in reporting to the general purpose computer.

Inspection of FIG. 2 illustrates that the software executing in general purpose computer 202 need only issue commands to perform a given function, to a virtual money handling peripheral device, without necessarily knowing the model of money handling peripheral device which will carry out that function. As a practical matter, general purpose computer 202 may also be used as a maintenance tool and as a software maintenance tool. Because of this dual use of general purpose computer 202, the computer may well be aware of the model and manufacturer of the particular money handling peripheral device currently coupled to interface device 204. In particular, general purpose computer 202 may have the software modules stored in the general purpose computer for downloading to interface board 204. General purpose computer 202 may thus be used to download the appropriate software modules or drivers to interface device 204 as well as to allow other software maintenance of the software modules, for example, updating the drivers, communicating with the various money handling peripheral devices. In some embodiments of the invention, interface device 204 may include software modules or drivers residing on the board, where more than one software module for the same money handling peripheral device type resides on the board, with only the currently required software module being active.

In another example of use of the present invention, user interface software executing in personal computer 202 may send a message to interface device 204 to instruct bill validator 218 to prepare to receive the money. In some devices, this message is sent as an “enable” command. As previously discussed, the enable bill validator command is a common command issued from the general purpose computer 202 to a virtual money handling peripheral device on interface device 204, regardless of the model of bill validator currently connected to interface device 204. With bill validator 218 enabled, the bill validator is enabled and awaiting insertion of paper currency. As the paper currency is inserted into bill validator 218, data may be transferred from bill validator to interface device 204. In some embodiments, interface device 204 must run relatively fast software having short interrupt response times in order to catch data being presented through secondary communication port 219. In particular, in the case of coin validator or coin acceptors, a very fast software loop is preferably executed within interface device 204. As the data is received by interface device 204, it is converted into a common format reporting message and transmitted through primary port 216 to general purpose computer 202.

Using bill validator 218 as an example, the bill validator is the money handling peripheral device “type” with various manufacturers supplying different money handling peripheral device “models” of that type. One bill validator may be made by JCM while another bill validator may be made by Cash Code. The software to communicate with the JCM bill validator is most likely entirely different from the software used to communicate to the Cash Code bill validator. When the JCM bill validator is coupled to the kiosk, being attached to port 219, the required software for communicating to JCM bill validator can be loaded into the interface device 204. In some examples of the invention, the JCM communication software will reside in general purpose 202, although the software is unlikely to be executable on general purpose computer 202. As part of the maintenance/installation procedure, the JCM communication software can be downloaded through primary communication port 216 to interface device 204. In some embodiments of the invention, the software required to communicate with the Cash Code bill validator will also reside on general purpose computer 202, although not presently required. In some examples of the invention, both the JCM software and the Cash Code software will reside on interface device 204, with only one being active at the same time.

The software modules or drivers used to execute on interface device 204 and communicate with the bill validator 218 are typically specially written software modules adapted to run on interface device 204 and communicate out the various secondary communication ports of interface device 204. In one example, the software modules are written in the C programming language, and compiled, and/or a combination of C and assembler language. The software modules can be specifically written to recognize the addressing scheme of the various secondary communication ports. The software modules may be specifically adapted to run under the control of the kernel or real time operating system of device 204. In one embodiment of the invention, the software modules executable on interface device 204 are called by interrupt service routines executing on interface device 204, where the interface device has no operating system or kernel, having only a round robin code loop with interrupts.

When a new bill validator is desired, for example, a newer or less expensive model, the current bill validator may be removed and replaced with a different model bill validator. An appropriate software module or driver matched to that new bill validator can be downloaded to personal computer 202, for example, through a network or a removable media such as a computer diskette. The software module or driver can then be downloaded through primary communication port 216, to interface device 204. With the maintenance procedure completed, normal operation of the device can be resumed. As previously stated, the commands issued to the new model bill validator through primary port 216 can be identical to the previous commands issued to the previous model of bill validator. Similarly, the information or data received from the new model bill validator can be the same as the previous data messages received from the previous bill validator model. In this way, in normal operation, general purpose computer 202 issues commands to, and receives messages from, only virtual money handling peripheral devices, rather than specific money handling peripheral devices. The particular model of money handling peripheral device is thus transparent to the general computer 202 during normal operation. In a maintenance mode, however, the particular model of the money handling device type may well be known to general purpose computer 202 as the general purpose computer was used to install the software for the money handling device type model.

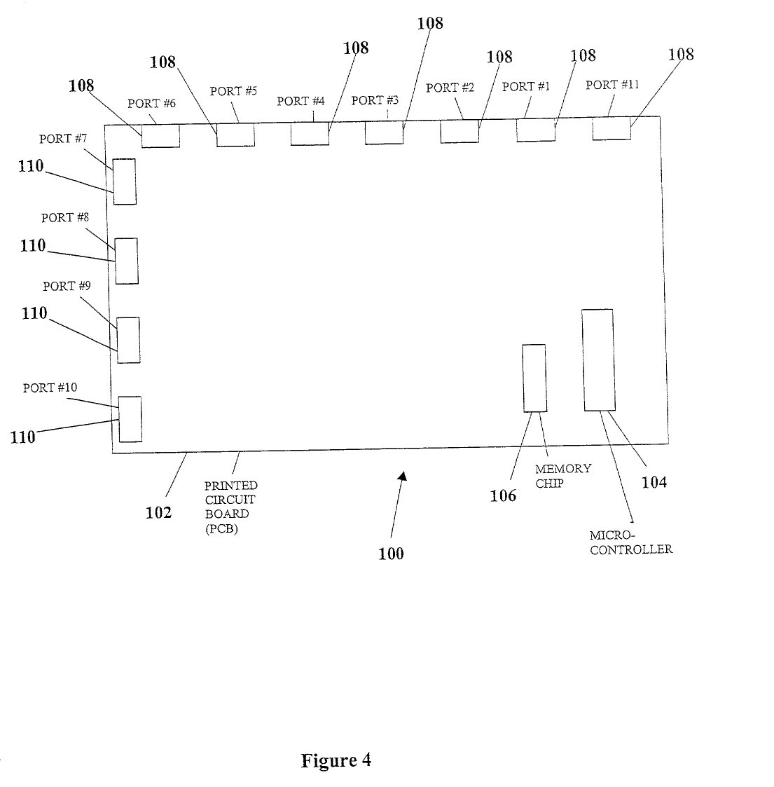

FIG. 4 illustrates one interface device example in Intelligent Multipurpose Control Interface (IMCI-81) 100. IMCI-81 100 is one example of an interface device. Any suitable interface board capable of running the invention software sufficiently fast and having the communication ports for communicating with the money handling peripheral devices may be used in place of IMCI-81 100. IMCI-81 100 is comprised of printed circuit board (PCB) 102, which includes at least one microcontroller 104, at least one memory chip 106, a plurality of serial communication ports 108, and a plurality of parallel communication ports 110. As stated above, IMCI-81 100 performs the functions of interpreter, traffic cop, and security guard through its interaction with the general purpose computer and the plurality of money-handling peripheral devices. As will be discussed below, IMCI-81 100 is much more than a typical multiplexer or port multiplier. IMCI-81 100 provides improved reliability and control, as opposed to prior alternatives previously discussed. Further, IMCI-81 100 can support a broad range of money- handling peripheral devices, regardless of whether their interfaces are serial, or parallel and can perform this interaction with very limited instruction.

PCB 102 can be any type of printed circuit board, such as a 2 or 4 layer plated through tin-lead re-flow board with a silkscreen solder-mask board. In one embodiment, the PCB is a 2 layer silkscreen solder-mask board. The locations of the main components on PCB 102 are shown in FIG. 4. PCB 102 plays an important role in the invention by housing microcontroller 104, memory chip 106, serial ports 108, and parallel ports 110, and providing the interconnects between them.

Microcontroller 104 can be any type of microcontroller, such as an M68HC11 manufactured by Motorola® or a COP8AME9 manufactured by National Semiconductor®); however, microcontroller 104 is preferably a DS87C520 8051 based RISC microcontroller manufactured by Dallas Semiconductors®. The 8051 microcontroller is a member of MCS-51 family. The 8051 core includes several on-chip peripherals, such as timers, counters, on-chip data memory, and up to 16K (in DS87C520), 32K, or 64K bytes of on-chip program memory.

Microcontroller 104 preferably has an 8-bit CPU optimized for control applications, extensive Boolean processing (single-bit logic) capabilities, 64K program memory address space, 64K data memory address space, up to 64K bytes of on-chip program memory (ROM), 128 bytes of on-chip data RAM, 4 8-bit wide ports outputs (byte or bit addressable), four 8-bit wide ports inputs (byte or bit addressable), two 16-bit timer/counters, and 6-source/5-vector interrupt structure with two priority levels. As stated above, microcontroller 104 is a RISC based processor, meaning it is a reduced instruction set computer, which recognizes a relatively limited number of instructions. One advantage of using the RISC based microcontroller 104 in the present invention is that it can execute its instructions very fast because the instructions are so simple, and thus increases the speed of the system. Even more advantageous is that the microcontroller 104 is RISC based; therefore, it requires fewer transistors, which makes it cheaper to design and produce.

Memory chip 106 can be comprised of any type of programmable memory, such as any PROM, EPROM, or EEPROM; however, memory chip 106 is preferably serial memory, and more specifically 32K ×8 Flash EEPROM, such as with the AT29C256, manufactured by Atmel®. Memory chip 106 has serial 256K EEPROM, providing high reliability and high performance. Its 256K of memory is organized as 32,768 words by 8 bits. Memory chip 106 is chosen specifically for its low power consumption (50 mA Active Current—300 μA CMOS Standby Current) and low voltage applications (Vcc =5 V). Memory chip 106 is utilized to store a variety of programming and mapping tables, which is discussed in more detail below.

Communication serial ports 108 are available in a variety of hardware standards, including the RS-232C, which supports two types of connectors—the 25-pin D-type connector (DB-25) and the 9-pin D-type connector (DB-9). A RS-232C port is preferred because most personal computers have an RS-232 port, used for connecting to another device. RS-422 & RS-423 ports, which are designed to replace the older RS-232 standard, are sufficient alternatives and growing in popularity because they support higher data rates and have greater immunity to electrical interference. An RS-422 supports multipoint connections, whereas an RS-423 supports only point-to-point connections. Also available is the RS-485, which supports several types of connectors, including DB-9 and DB-37. An RS-485 is similar to an RS-422, but can support more nodes per line because it uses lower-impedance drivers and receivers. In addition, an Centronics interface parallel port, which uses a 25-pin connector (type DB-25), may be used. All of these communication serial ports 108 can be utilized by IMCI-81 100 to connect with the general purpose computer and the various money-handling peripheral devices as is discussed below.

The general purpose computer is linked to IMCI-81 100 via an RS-232 serial interface at Port #11 located on PCB 102 operating at 9600 baud; however, it is contemplated that the general purpose computer and IMCI-81 100 could communicate with any type communication protocol, including parallel and optical communication standards. The communication between the general purpose computer and IMCI-81 100 is preferably Request-to-Send/Clear-to-Send handshaking protocol, which means the general purpose computer or IMCI-81 100 can either receive or transmit, but not both at the same time. Basically, one device will send a Request-to-Send signal to a second device signifying a request to send information. The second device will send a Clear-to-Send signal back to the device signifying that the second device is able and prepared to receive information. Further, a custom packet protocol, with a checksum error detection scheme, is utilized to guarantee the connectivity between the general purpose computer and IMCI-8 1 100. The checksum error-detection scheme sends a numeric value, based on the number of set bits in the message, with each transmitted message. The receiving station then applies the same formula to the message and checks to make sure the accompanying numerical value is the same. If not, the receiver can assume that the message has been garbled.

In a preferred embodiment, IMCI-81 100 has 11 external communication ports. Seven of these ports are preferably the already described serial ports 108, meaning the data is transferred one bit at a time. Each external serial port is fully configurable in terms of parity (ensuring the validity of the data), stop bit selection (ensuring a full message is sent), word length (the amount of bits in a message), etc. The serial data can be sent at baud rates of 2400, 4800, and 9600, as selected by the licensee. Further, as also discussed above, a variety of serial hardware standards are supported in addition to the RS-232C standard, such as RS-422 and RS-485. Therefore, these various connection ports make IMCI-81 100 flexible and expandable by allowing for currently unsupported peripherals or unique/obsolete protocol standards to be added in the future either with custom port adapters or simple modifications to the PCB. One of the serial ports 108 links the general purpose computer to the ICMI-81 100 using an RS-232, while the remaining six serial ports 108 are capable of standard RS-232C communication. Further, it is contemplated that some of these six remaining ports may provide dual functions. For example:

Port #1 is RS-232C / Variation of RS-422

Port #2 is RS-232C

Port #3 is RS-232C

Port #4 is RS-232C

Port #5 is RS-232C

Port #6 is RS-232C / RS-485

The modular design of the system limits driver activation for the various money-handling peripheral devices under IMCI-81 100 to a single driver at a time. Thus, only one money-handling peripheral device can operate at a time. This is due in part to the hardware design and the amount of RAM available for buffer storage, and more importantly, to prevent loss of information, which is a large security concern. Although only one money-handling peripheral device at a time is permitted to operate by IMCI-81 100, multiple devices can be set to “listen mode”. In “listen mode”, when a money-handling peripheral device is activated by a licensee (e.g., the user inserts a bill into a bill validator), the money-handling peripheral device sends a signal to IMCI-81 100, informing IMCI-81 100 that the money-handling peripheral device is ready to be operated at the next possible opportunity. When IMCI-81 100 has completed an operation with another money-handling peripheral device, IMCI-81 100 will then react to the first port where an money-handling peripheral device has sent a signal in the “listen mode”. This action by IMCI-8 1 100 is referred to as multi-port listening.

Multi-port listening allows IMCI-81 100 to immediately switch drivers to correspond with the money-handling peripheral device, which has sent a signal in the “listen mode” so that it may communicate with the money-handling peripheral device. Once communication begins on a port, the port becomes active and takes precedence (priority) over all other ports until the serial data stream stops. This methodology ensures reliable communication. An example illustrating that multi-port listening is beneficial occurs when the money-handling peripheral device user utilizes both a magnetic card reader and a barcode scanner in order to enter his identification information. Thus, with multi-port listening, the IMCI-8 1100 reacts to the first source of input. This feature can be used to monitor bill insertion and coin insertion, again accepting the first port to display activity and then processing the port that was second to display activity in the “listen mode”. Multi-port listening may be activated at a combination of money receptors, whether controlled by serial or parallel port. It may also be invoked, by a single command, across all serial drivers.

The four remaining parallel ports 110 can be of various configurations, in much the same fashion as previously discussed with the serial ports 108. These parallel ports 110 are typically designed for specific devices, but, as also discussed above, could easily be adapted to control currently unsupported peripherals and future products. Further, most of the collection ports, whether serial 108 or parallel 110, utilize open collector outputs, which simplify possible modification to support unique or future hardware.

As stated above, IMCI-81 100 can support any money-handling peripheral device, however, in the preferred embodiment, IMCI-81 100 will support devices such as a JCM Bill Validator and JCM Bill Dispenser, a Cash Code bill validator, a De La Rue MDDM Bill Dispenser, a Coin Controls C435 coin validator, an SCR Dual Track insert Card Reader, and an FTS Serial Fixed Mount Bar Code Scanner, an Epson Serial Printer. With reference to FIG. 4, port #1 is an RS-232C connector which can be connected to the JCM Bill Validator, port #2 is an RS-232C connector which can be connected to the SCR Dual Track insert Card Reader, port #3 is an RS-232C connector which can be connected to the Epson Serial Printer, port #4 is an RS-232C connector which can be connected to the FTS Serial Fixed Mount Bar Code Scanner, port #5 is an RS-232C connector which can be connected to the De La Rue MDDM Bill Dispenser, port #6 is an RS-232C connector which can be connected to the JCM Bill Dispenser, port #7 is multi-pin connector which can be connected to the Coin Accepter, port #8 is an multi-pin (molex) connector which can be connected to the Coin Dispenser. Port #11 is a 9600 Baud serial link to the general purpose computer and Ports 8 and 9 are configured as port #8 permitting connection of multiple coin dispensers. Ports #7, #8, #9, #10 are not serial ports and may be configured in software to control almost any device.

If a licensee wishes to update or switch out any money-handling peripheral device, then they would simply inform the IMCI-81 100 developers that they are planning to update or switch out a peripheral device. Upon the licensor agreeing to license the IMCI-81 100 drivers for the updated or new money-handling peripheral device, the licensor or an administrator then will load the IMCI-81 100 drivers for the new money-handling peripheral onto the memory chip 106, previously housing the driver for the money-handling peripheral being replaced. The driver can be downloaded from a network connection or can be loaded locally at the general purpose computer. The licensee is also given a password or pin number, which allows microprocessor 104 to identify and properly use the encrypted driver software for the updated or new money-handling peripheral device. If the password or pin number is not obtained, then IMCI-81 100 cannot utilize the driver. This improved system relieves the licensee of having to write driver applications for the new money-handling peripheral device or having to develop software to integrate several unique money-handling peripherals. As stated previously, IMCI-81 100 utilizes a 32K X 8 Flash EEPROM for non-volatile storage. Within the 256k available, approximately 400 bytes are consumed for storing settings, necessary for operation of the IMCI-81 100. The remaining bytes are available for general licensee storage, arranged in 8 byte blocks. The table below shows a preferred embodiment of the allocation of memory in microprocessor 104 and memory chip 106.

| | |
|---|---|
| 0000-3FFF | This code space uses very limited resources. The purpose of the |
| (microprocessor | microcontroller 104 ROM memory is to provide a means to load system |
| ROM) | code into the Flash/Non Volatile ram chip. All system configuration and |
| | sensitive code is located in this memory space. This includes all |
| | EEPROM encryption tables, EEPROM read/write, microcontroller 104 ID |
| | (serial number), interrupt vectors and functions, and logging functions. |
| Flash Memory | IMCI-81 100 program code is stored in this location. Further, because this |
| 0000-7FFF | is Flash memory, the program code can be updated when necessary, and |
| | more importantly, can be updated remotely. A built in transaction-logging |
| | feature uses this EEPROM to record each client transaction to insure the |
| | security of the transaction and prevent any inaccurate transactions. The |
| | IMCI-81 100 stores unique keys, not customer account numbers, in this |
| | EEPROM, for security reasons. |
| Flash Memory | All money-handling peripheral interface hardware is memory mapped to |
| 8000-FFFF | this range. |

IMCI-81 100 provides two levels of data encryption. The purpose of data encryption in the IMCI-81 100 is to protect the owner or licensee of the IMCI-81 100 from piracy. License information and the EEPROM encryption lookup table are transferred to IMCI-81 100 in encrypted format. 15 different tables may be chosen, in concert with 65535 available unique chip serial numbers, providing a total of 983,025 unique encryption environments. The licensee would be able to use the same encryption table for all of their units, with the Chip or System serial number providing the unique security for individual IMCI-81 100.

In addition to the encryption process between the IMCI-81 100 and the general purpose computer, table encryption (indexing) is used to encrypt data transfer between Microprocessor 104 and memory chip 106, utilizing EEPROM. This table is uniquely programmed upon initial IMCI-81 100 setup at the factory or distribution outlet. This table protects the Licensee from piracy, or the simple act of copying the contents of one memory chip 106 to another, and thus, providing full functionality to a product that was not so licensed. The internal table provides for 16,711,425 unique tables.

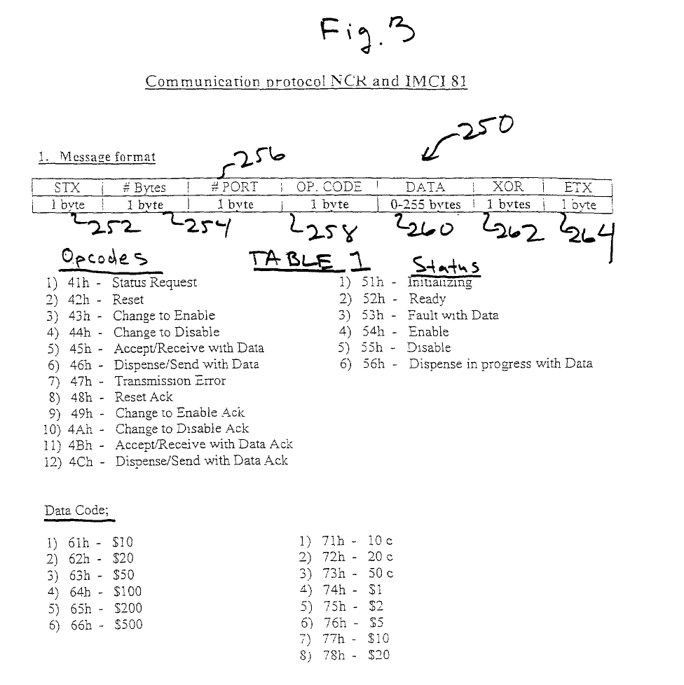

FIG. 3 illustrates the communication message or protocol between general purpose computer 202 and interface device 204 through primary communication port 216, previously discussed with respect to FIG. 2. In a preferred embodiment, the same communication protocol or message protocol is utilized in both communicating from general purpose computer 202 to interface device 204, and from interface device 204 to general purpose computer 202. Standard message format 250 may be seen to include a start of transmission (STX) byte 252, a number of bytes, byte 254, a port number 256, an op code 258, a data portion 260, an exclusive or check sum (XOR) byte 262, and an end of transmission (ETX) byte 264. It should be noted that message 250 is typically not aware of the model of money handling peripheral device to which it is being sent or received from, as it is being sent to and from a virtual device.

In one embodiment of the invention, the port numbers at which the money handling peripheral devices reside are known by general purpose computer 202, and are used to direct the message to the appropriate port. Thus, when a $20 bill is to be dispensed from a bill dispenser, the general purpose computer knows the correct port number to send the message to. The general purpose computer often knows the port number, as the general purpose computer is generally involved in the software maintenance and installation of the bill dispenser. The same is true of the other money handling peripheral devices and other I/O devices such as the bar code scanners and magnetic card readers.

Table 1 includes a list of various op codes which can be included in op code field 258. A status request op code may be transmitted for querying the status of the various money handling peripheral devices and I/O devices. A reset op code may be sent to reset the various money handling peripheral devices. A change to enable op code may be sent to enable the money handling peripheral devices. A change to disable op code may be sent to disable the money handling peripheral devices. An accept/receive with data op code may be used to send data from the money handling peripheral device to the general purpose computer. A dispense/send with data op code may be used to instruct a money dispensing peripheral device such as a bill dispenser or coin dispenser to dispense currency, along with data indicating the amount of currency to be dispensed. A transmission error op code may be sent from the general purpose computer, or the various money handling peripheral devices, to indicate a transmission error. A reset ack or acknowledgement op code may be sent to acknowledge the receipt and successful completion of a reset operation by the money handling peripheral devices. A change to enable acknowledge op code may be sent by the money handling peripheral devices to acknowledge the successful change to enable. A change to disable acknowledgement op code may be sent from the money handling peripheral devices to the general purpose computer to indicate the successful completion of a disable operation. An accept/receive with data acknowledgement may be used to acknowledge the successful reception of data received. A dispense/send with data acknowledgement op code may be used to acknowledge the receipt of a dispense or send op code together with data.

The present invention includes an interface device disposed between a general purpose computer and money handling peripheral devices, as previously described. The general purpose computer can execute operator interface or graphical user interface (GUI) programs to provide and interface with the person using the general purpose computer. In some examples, the GUI will provide the interface for a money repository at a convenience store or gasoline or petrol station. Such an interface may require the operator to login via a touchscreen or through swiping an ID card. The GUI may then prompt the user for the amount of money being entered. In another example, the GUI may provide the interface for a consumer to pay bills, such as utility, cellular phone, or satellite television bills. Such GUI programs are well known and vary from one use of the present invention to the next use.

A program executing on the general purpose computer will ultimately send commands to the interface device board to control various money handling peripheral devices. The general purpose computer will also receive responses back from the money handling peripheral devices through the interface device. The communication between the general purpose computer and the interface device is accomplished through messages. The general purpose computer is responsible for generating, sending, receiving, and interpreting messages to and from the interface board. Once provided the message format, writing computer programs for generating and interpreting the messages is easily accomplished.

The interface device can be responsible for receiving and interpreting messages from the general purpose computer, then controlling the money handling peripheral devices as required. Control of money handling peripheral devices varies from device to device, and is well known to those skilled in the art. Vendors of such devices typically provide sufficient documentation with the device to enable the purchaser to control and read the device. This documentation is available from each vendor, and need not be duplicated here. The documentation is sufficient to enable the devices such as coin validators, bill validators, coin dispensers, and bill dispensers to be incorporated in many different and numerous devices seen every day. Examples of such devices include numerous vending machines, pay phones, change machines, and automatic teller machines.

In order to further illustrate the present invention, examples of message formats for some money handling peripheral devices are provided below. Examples of commands sequences and responses are also provided. Software engineers, once provided the message format used in a particular embodiment of the invention, will be able to write computer code appropriate for the particular purpose and money handling peripheral device.

### Example 1

### Command Sequence Sample

Example 1 contains an example sequence of commands to a NMD 100 Bill Dispenser (MDDM) interface device through the Intelligent Multiport Control Interface (IMCI-81) interface device. PC commands do not start with an asterisk(*), while IMCI-81 responses begin with an asterisk(*).

| COMMAND | Comments |
|---|---|
| Status Request | Determine MDDM state before attempting to |
| | Enable |
| *ENABLED, DISABLED, | Under normal conditions, the MDDM will be |
| FAULT_DATA, READY, | in “DISABLED” condition. Ready for the |
| INITIALIZING, | next Dispense sequence. |
| ESCROW_DATA, | |
| ACCEPTING_DATA | |
| XENABLE | “Change to Enable” |
| *XENABLE_ACK | “Change to Enable Ack” - MDDM ready to |
| | dispense bills |
| TX_DATA | ESCROW BILLS - Prepare bills for |
| | dispense. Multiple denominations from |
| | multiple hoppers may be dispensed, up to a |
| | maximum total of 100 bills. |
| *TX_DATA_ACK | IMCI verifies MDDM has moved requested |
| | number of bills forward, then replies to PC |
| | with actual bills prepared (escrowed) for |
| | dispense. |
| STACK | ISSUE Bills to customer. |
| *STACK_ACK | Issued following removal of bills from lift. |
| | (Successful Dispense) |
| Status Request | Verify that MDDM is “DISABLED” |
| *DISABLED | MDDM is “DISABLED” after a DISPENSE |
| | sequence. |

### Example 2

The tables in Example 2 below contain examples of messages sent between the general purpose computer and the interface device (IMCI-81) Example 2 contains example messages for a JCM model bill validator. The opcodes given below are arbitrary, and may have other values in other embodiments of the invention. The tables contain information understandable to software engineers and requires no further explanation. The examples are provided to illustrate messages which are sent to and from the interface device in one working example of the invention.

| | # | | | | | |
|---|---|---|---|---|---|---|
| STX | Bytes | # PORT | Op. Code | *Data | XOR | ETX |
| 02 | 4 + | 1 = BVJCM | See below | Date (see | #bytes-end | 03 |
| | data | | | attached) | data | |

CONTROL COMMANDS (PC to IMCI-81)

| | |
|---|---|
| 41h - STATUS | |
| STATUS REQUEST | Requests current state of BVJCM (ENABLED, DISABLED, |
| | FAULT WITH DATA) |
| Additional Data required | Nil |
| Example PC → IMCI-81 | 02 04 31 41 XX 03 |
| Example: IMCI-81 → PC | 02 04 31 65 50 03 (65h = Disabled) |
| Notes: | Most devices attached to IMCI-81 will report ENABLED or |
| | DISABLED or FAULT WITH DATA ONLY. BVJCM can |
| | return a variety of status messages. |
| 42h - RESET | |
| RESET DEVICE | Restores start up condition |
| Additional Data required | Nil |
| Example PC → IMCI-81 | 02 04 31 42 77 03 (note: 77 is XRC) |
| Example: IMCI-81 → PC | 02 04 31 52 67 03 (52h = RESET_ACK) |
| Notes: | BVJCM responds with RESET_ACK. If device had been offline |
| | (require attendant) it can now be enabled. |
| 43h - XENABLE | |
| CHANGE TO | Change BVJCM to ENABLED |
| ENABLE | |
| Additional Data | nil |
| required | |
| Example PC → | 02 04 31 43 76 03 |
| IMCI-81 | |
| Example: IMCI-81 → | 02 04 31 53 66 03 (53h = XENABLE_ACK) |
| PC | |

Notes: Once ENABLED, device must accept a valid bill within 64 seconds, or a device timeout
will occur and the BVJCM will revert to DISABLED status. NOTE: Only one device may be
enabled at a time. A FAULT_DATA code of DRV_OTHER_DEV_INIT is returned if
XENABLE is attempted while another device is Enabled. A STAT_REQUEST on Port 0
provides a fast and efficient method of revealing the status of all ports.

| | |
|---|---|
| 44h - XDISABLE | |
| CHANGE TO DISABLE | Change BVJCM to DISABLED |
| Additional Data required | Nil |
| Example PC → IMCI-81 | 02 04 31 44 71 03 |
| Example: IMCI-81 → PC | 02 04 31 54 61 03 (54h - XDISABLE_ACK) |

Notes: All devices attached to IMCI-81 will report ENABLED or DISABLED or FAULT WITH
DATA ONLY. A driver which is in an ERROR state may be returned to normal operation with
the XDISABLE command. The exception to this rule is any error greater than F0h The IMCI-81
first tests the JCM Validator for a “safe” status before disabling. (i.e. Not accepting or rejecting.)
If mouth is obstructed, IMCI-81 will attempt to disable for a maximum of 35 seconds, then set the
Device to failure (FFh) and return “DRV_UNABLE_DISABLE”. In the event of Disable attempt
during an accept process, fault/accepting will be returned, or the IMCI-81 will hold CTS line in
busy state until the accepting process has completed.

| | |
|---|---|
| Upon receiving | Echo IMCI-81 report of Accepted bills with data. (two bytes data |
| ESCROW_DATA (47h) | required) (mirror of data received from IMCI-81) |
| opcode from IMCI-81, the | D1 - Data byte #1 = Hopper number |
| PC replies with this | D2 - Data byte #2 = Quantity (always = 1 for a receptor) |
| command to verify the data. | |
| Additional Data required | D1 & D2 |
| Example PC → IMCI-81 | 02 06 31 56 D1 D2 XX 03 *** 2. Response to IMCI-81 (ECHO |
| | DATA) |
| Example: IMCI-81 → PC | 02 06 31 46 D1 D2 XX 03 *** 1. This command sent to |
| *** | PC/HOST |
| Notes: | The BVJCM expects acknowledgment of valid data received |
| | from host PC within 6 seconds. See samples in the attached |
| | Appendix for clarification. |
| 4Ch - PASSTHROUGH | |
| PASSTHROUGH | Send EXACT data to BVJCM. This is used primarily for |
| | testing/debugging, or to support future improvements in the JCM |
| | device itself |
| Additional Data required | Nil |
| Example PC → IMCI-81 | 02 XX 31 4C D0 D1 ... DX 03 |
| Example: IMCI-81 → PC | 02 04 31 5C XX 03 (5Ch = PASSTHROUGH_ACK) |
| Notes: IMCI-81 >> PC | IMCI-81 will add BVJCM packet requirements. This command |
| | MUST include at least 1 data byte. (BVJCM internal opCode) |

IMCI-81/DEVICE RESPONSES (IMCI-81 to PC)

| | |
|---|---|
| 53h - XENABLE_ACK | |
| CHANGE TO ENABLE | Response to PC request to CHANGE TO ENABLE was received, |
| ACK | and carried out, by driver. |
| Additional Data included | Nil |
| Example | 02 04 31 53 XX 03 |
| Notes: IMCI-81 → PC | |
| CHANGE TO DISABLE | Inform PC that request to DISABLE was received, and carried |
| ACK | out, by driver. |
| Additional Data included | Nil |
| Example | 02 04 31 54 XX 03 |
| Notes: IMCI-81 → PC | |
| 63h - FAULT_DATA | |
| FAULT with DATA | FAULT with at least one byte of ERROR CODE data. Note |
| | DRV_DEV_SPECIFIC discussed in the attached Appendix. |
| Additional Data included | Returns error code, 1 byte or more. |
| Example (IMCI-81 to PC) | 02 05 31 63 DD XX 03 |
| Notes: IMCI-81 → PC | Data byte contains important information about the status of |
| | BVJCM bill validator. Reference the ERROR CODE manual for |
| | a complete description, or consult Appendix I in this datasheet |
| Information only message | The JCM Bill Validator sends one information message. |
| from driver. The Host | “INFO_STARTACCEPT“ (40h) is sent to the Host when a bill is |
| should not reply to this | detected entering the Validator. |
| message. | |
| Additional Data required | D1 (40h) |
| Notes: IMCI-81 → PC | 02 04 31 4D D1 XX 03 (Where D1 = 40h) |
| A valid bill has been received | Announce to PC that a valid bill has been detected, and is now |
| and is now stacked. IMCI81 | Stacked. |
| expects an echo of the | D1 - Data byte #1 = Hopper number |
| RX_Data Hopper & Qty | D2 - Data byte #2 = Quantity (always = 1 for a receptor) |
| within 6 seconds. | |
| Additional Data required | HH=Hopper Number (Type of Bill) QQ=Quantity (Always = 1 |
| | for validator) |
| Example | 02 06 31 46 HH QQ XX 03 |

The BVJCM expects acknowledgment of valid data received from host PC within 6 seconds. The
JCM Driver will only accept STATUS and RX_DATA_ACK commands for 6 seconds following
this message.

| | |
|---|---|
| Announce bill in Escrow. | Announce to PC that a valid bill has been detected, and is now In |
| This message is only sent for | Escrow. |
| bills that have been enabled | D1 - Data byte #1 = Hopper number |
| by the “SYS_SET_{—} | D2 - Data byte #2 = Quantity (always = 1 for a receptor) |
| OPTION” command. | |
| Additional Data included | HH = Hopper Number (Type of Bill) QQ=Quantity (Always = 1 |
| | for validator) |
| Example | 02 06 31 48 HH QQ XX 03 |

This message indicates that a bill is ready to be stacked. Issuing the “STACK” command will
initiate the stacking process. Issuing the “XDISABLE” command will reject the bill and disable
the Validator.

| | |
|---|---|
| 62h - READY | |
| Ready | Ready is used to indicate valid ESCROW_DATA_ACK was |
| | received from PC as expected. |
| Additional Data required | Nil |
| Example | 02 04 31 62 XX 03 |
| Notes: IMCI-81 → PC | |

SYSTEM COMMANDS

** System codes require opCode 4Fh, and the additional system code passed as the first byte of data.

| | |
|---|---|
| 2Ah - | |
| SYS_SET_OPTION | |
| System Command: | Sets DENOMINATION “In Service” option. Value requires two |
| SYS_SET_OPTION | bytes and is implemented in bitwise fashion. |
| Additional Data required | 2A, SYSTEM CODE/D1, D2 are Denomination accepted setting data. |
| Example | 02 06 31 4F 2A D1 D2 XX 03 |
| Notes: | See example below. |
| 2Bh - | |
| SYS_GET_OPTION | |
| Returns status of BANK | Returns DENOMINATION “In Service” option. Two data bytes are |
| option. | returned. |
| Additional Data required | 2B SYSTEM CODE |
| Example | 02 05 31 4F 2B XX 03 (request system option) |
| (sys_get_option) | 02 05 31 5F D1 D2 XX 03 (5Fh = SYSTEM_ACK, D1, D2 = current |
| (system_ack) | bank setting) |
| Notes: | See example below. |

### Example 3

### Driver: MDDM 300 Bill Dispenser

The description in Example 3 below contains example psuedo code of communication and logic executed in and between the general purpose computer and interface device to operate the MDDM 300 bill dispenser. The example below is understandable to software engineers and should require no further explanation. The examples are provided to illustrate control logic and communication which could can be provided in addition to the opcode tables of Example 1, to further illustrate use of the invention to software engineers. Software engineers can use the opcode tables, and optionally, some psuedo code, to write simple programs on a general purpose computer.

Pseudo-Code:

Pseudo-code is simplified as much as possible. IMCI-81 internal processes may require a great deal of error checking and validation for each command issued. This complexity is hidden from the Host control PC and greatly reduces logic complexity for the PC application developer.

A. PC command logic is displayed in BOLD typeface.

B. IMCI81 internal logic is in REGULAR typeface.

C. Comments are in italic font and preceded by a double forward hash //

D. ** “Send data to device”. Also indicates that the IMCI-81 performs command formatting so that the destination device understands instructions. In addition, this indicates that the IMCI-81 waits for and interpret a response from the device. In general, an expected or maximum reply time is noted in comment form to the right

MDDM: STATUS_REQUEST (41h) PSEUDO-CODE

The MDDM 300 bill dispenser is an intelligent bill-dispensing device that consists of 1 to 8 hoppers containing one note type per hopper. The MDDM is connected to the IMCI81 using a RS232 serial connection.

The example below summarizes the general logic path from:

A. PC command to IMCI-81

B. IMCI-81 to MDDM communication (Multi-step process)

C. IMCI-81 reply to PC

------------------------------- BEGIN PSEUDO CODE ------------------------------------------------------

| | |
|---|---|
| PC Issues Command STATUS REQUEST (41h) | // Determine MDDM status or state |

(PC WAITS up to 180 seconds while IMCI81 performs processing (below))

| | |
|---|---|
| IMCI81 receives packet from PC | // IMCI81 Driver Routing logic |
| IMCI81 verifies packet | // IMCI81 Driver Routing logic |
| IMCI81 main loop routes instruction to MDDM driver | // IMCI81 Driver Routing logic |

Begin STATUS REQUEST process: (Determine MDDM status)
Verify that IMCI81 hardware (UART) is ready.

| | |
|---|---|
| BEGIN LOOP: | // loop through all cassettes (1-8) |
| [symbol] ** Verify that Cassette is installed | // each command requires a correctly |
| [symbol] ** Verify Cassette contains bills | // formatted structure for the MDDM |

[symbol]

** Verify Cassette is ready to deliver bills (No error conditions)

| | |
|---|---|
| [symbol] ** Issue MDDM “ReadCassetteID” command | // normally 0.5 sec wait for response |

[symbol]

Validate CassetteID against ID in IMCI81 EEPROM

| | |
|---|---|
| GOTO LOOP: | // Repeat test for next cassette |
| Verify MDDM general status | // Test for any error in MDDM |

Summarize general status of MDDM and of all cassettes examined
Report current MDDM state to PC (Enabled, Disabled, Ready, Error)

// Note: Error condition may

report

// additional information in the
Data// portion of the Packet

PC examines IMCI81 reply (opCode) for success or error condition
IF reply = error condition then handle Error
ELSE continue with next operation (possibly XENABLE)
---------------------------- END PSEUDO CODE ------------------------------------------------------------

MDDM: XENABLE_(43h) PSEUDO-CODE

Description:

The example below summarizes the general logic path from:

A. PC command to IMCI-81

B. IMCI-81 to MDDM communication (Multi-step process)

C. IMCI-81 reply to PC

------------------------------- BEGIN PSEUDO CODE ------------------------------------------------------------------

| | |
|---|---|
| PC Issues Command XENABLE (43h) | // Change to Enabled |

(PC WAITS up to 180 seconds while IMCI81 performs processing (below))
Verify Packet and perform IMCI81 Driver Routing Logic

| | |
|---|---|
| Begin XENABLE process: | // (Enable MDDM for bill dispensing) |

Verify that no other dispenser is currently ENABLED
** Verify that IMCI81 hardware (UART) is ready.
** Verify MDDM bundle unit clear of notes from previous operations
** Verify that Cassettes are “Opened” for dispensing

| | |
|---|---|
| BEGIN LOOP: | // loop through all cassettes (1-8) |
| [symbol] ** Verify that Cassette is installed | // IMCI81 formats each command for |
| [symbol] ** Verify Cassette contains bills | // the MDDM |

[symbol]

** Verify Cassette is ready to deliver bills (No error conditions)

| | |
|---|---|
| [symbol] ** Issue MDDM “ReadCassetteID” command | // normally 0.5 sec wait for response |

[symbol]

Validate CassetteID against ID in IMCI81 EEPROM

| | |
|---|---|
| GOTO LOOP: (More Cassettes to Validate?) | // Repeat test for next cassette |
| ** Verify MDDM general status | // Test for errors in other MDDM |

modules

| | |
|---|---|
| Setup monitoring parameters | // driver timeout, priority etc. |
| Send XENABLE_ACK (53h) to PC | // Ready to dispense bills |
| | // Note: Error condition may report |
| | // additional information in the Data |
| | // portion of the Packet |

PC examines IMCI81 reply (opCode) for success (XENABLE_ACK) or error
condition
IF reply = error condition then handle Error

| | |
|---|---|
| ELSE continue with next operation (possibly DISPENSE_DATA) | // Dispense With Data |

------------------------------- END PSEUDO CODE ------------------------------------------------------------------

MDDM: TX_DATA (47h) “Dispense with Data” PSEUDO-CODE

Description:

Compare the MDDM dispense process to that of the Money Controls UHMk-4 Coin dispenser.

The MDDM requires one additional step from the PC (for security).

The example below summarizes the general logic path from:

A. PC command to IMCI-81

B. IMCI-81 to MDDM communication (Multi-step process)

C. IMCI-81 reply to PC

---------------------------- BEGIN PSEUDO CODE ----------------------------------------------------------------------------------

| | |
|---|---|
| PC Issues TX_DATA (47h) | // Data portion of packet contains hopper(s) & quantity(s) |

(PC WAITS up to 180 seconds while IMCI81 performs processing (below))
Verify Packet and perform IMCI81 Driver Routing Logic

| | |
|---|---|
| Begin TX_DATA process: | // |
| Verify MDDM is ENABLED | // according to IMCI-81 |
| Validate data parameters | // hoppers exist and have |
| Verify that IMCI81 hardware (UART) is ready. | // sufficient notes to dispense |
| ** Send properly formatted dispense data command to MDDM. | // wait up to 180 sec. |

IF notes are assembled and prepared for delivery Issue TX_DATA_ACK to PC
// See MDDM Driver Datasheet for details of the TX_DATA_ACK packet.
PC examines IMCI81 reply (opCode) for success (TX_DATA_ACK) or error condition

| | |
|---|---|
| PC Issues STACK (4Ah) | // “STACK” delivers the notes |

(PC WAITS up to 180 seconds while IMCI81 performs processing (below))
Verify Packet and perform IMCI81 Driver Routing Logic

| | |
|---|---|
| Begin STACK process: | // Issue notes to customer |
| ** Issue MDDM “Deliver Notes” command | // up to 180 sec. |
| [symbol] ** Monitor note extraction | // verify notes removed |

Disable MDDM so further dispensing is not possible without re-enabling

| | |
|---|---|
| Send STACK_ACK (5Ah) to PC | // Notes delivered |

// Note: Error condition may report additional information in the Data portion of the Packet
PC examines IMCI81 reply (opCode) for success (STACK_ACK) or error condition
IF reply = error condition then handle Error

| | |
|---|---|
| ELSE dispense process is complete | // successful dispense |

------------------------------- END PSEUDO CODE ---------------------------------------------------------------------------------

### Example 4

### Money Controls UHMK-4 Coin Dispenser

UHM: STATUS_REQUEST (41h) PSEUDO-CODE

Formerly “Coin Controls”, the “Money Controls” UHMk-4 coin dispenser is a coin-dispensing device with minimal intelligence. The IMCI-81 supports up to three UHMk-4 hoppers connected to parallel-bus ports using current limited diode protected inputs and open collector outputs. The IMCI-81 communicates with the UHMk-4 via parallel-bus architecture. The example below summarizes the general logic path from:

A. PC command to IMCI-81

B. IMCI-81 to UHMk-4 communication (Multi-step process)

C. IMCI-81 reply to PC

------------------------------- BEGIN PSEUDO CODE ---------------------------------------------------

| | |
|---|---|
| PC Issues Command STATUS REQUEST (41h) | // Determine UHMk-4 status |

```
  (PC WAITS up to 2 seconds while IMCI81 performs processing (below))
  Verify Packet and perform IMCI81 Driver Routing Logic
```

| | |
|---|---|
| IMCI81 main loop routes instruction to UHMk-4 driver | // IMCI81 Driver Routing logic |

Begin STATUS REQUEST process: (Determine UHMk-4 status)

| | |
|---|---|
| BEGIN LOOP: | // detect hoppers |
| [symbol] ** Is hopper connected | // 0,1,2 or 3 hoppers installed |
| [symbol] ** Does hopper contain coins | // has selectable warning |

level [symbol]
** Is hopper Error Free?

| | |
|---|---|
| GOTO LOOP: | // Repeat test for next hopper |

```
  Summarize general status of UHMk-4 and of all hoppers examined
  Report current UHMk-4 state to PC (Enabled, Disabled, Ready, Error)
```

// Note: Error condition may

report

// additional information in the
Data
// portion of the Packet

```
  PC examines IMCI81 reply (opCode) for success or error condition
  IF reply = error condition then handle Error
  ELSE continue with next operation (possibly XENABLE)
------------------------------- END PSEUDO CODE -----------------------------------------------------
```

UHM: XENABLE (43h) PSEUDO-CODE

The example below summarizes the general logic path from:

A. PC command to IMCI-81

B. IMCI-81 to UHMk-4 communication (Multi-step process)

C. IMCI-81 reply to PC

------------------------------- BEGIN PSEUDO CODE ---------------------------------------------------------

| | |
|---|---|
| PC Issues Command XENABLE REQUEST (43h) | // Change to Enabled |

```
  (PC WAITS up to 2 seconds while IMCI81 performs processing (below))
  Verify Packet and perform IMCI81 Driver Routing Logic
```

| | |
|---|---|
| IMCI81 main loop routes instruction to UHMk-4 driver | // IMCI81 Driver Routing logic |

```
  Begin XENABLE process:
  Verify that no other dispenser is currently ENABLED
  Verify minimum of one UHMk-4 hopper is connected and contains coins
```

| | |
|---|---|
| Send XENABLE_ACK (53h) to PC | // Ready to dispense coins |

```
  // Note: Error condition may report additional information in the Data portion of the Packet
  PC examines IMCI81 reply (opCode) for success (XENABLE_ACK) or error
  condition
  IF reply = error condition then handle Error
```

| | |
|---|---|
| ELSE continue with next operation (DISPENSE_DATA) | // Dispense With Data |

------------------------------- END PSEUDO CODE ------------------------------------------------------------

UHM: TX_DATA (47h) PSEUDO-CODE

The UHMk-4 coin-dispenser is capable of dispensing up to 50 coins in one coin denomination at a time. For example, you are not able to dispense 5 cent and 10 cent coins simultaneously. This is to simplify the error handling process for the PC, and improve the dispensing accuracy of the UHMk-4

The example below summarizes the general logic path from:

A. PC command to IMCI-81

B. IMCI-81 to UHMk-4 communication (Multi-step process)

C. IMCI-81 reply to PC

------------------------------- BEGIN PSEUDO CODE ------------------------------------------------------

| | |
|---|---|
| PC Issues TX_DATA (47h) | // Data portion of packet contains hopper(s) & quantity(s) |

```
  (PC WAITS up to 1 second per coin while IMCI81 performs processing (below))
  Verify Packet and perform IMCI81 Driver Routing Logic
```

| | |
|---|---|
| IMCI81 main loop routes instruction to UHMk-4 driver | // IMCI81 Driver Routing logic |

```
  Begin TX_DATA process:
  Verify that no other dispenser is currently ENABLED
  ** Is requested hopper functional?
  ** Does requested hopper have coins in it?
  ** Issue command to UHMk-4 to dispense requested number of coins.
```

| | |
|---|---|
| BEGIN LOOP: | // LOOP once per coin |
| [symbol] Monitor coin exit time | // watch for multiples |
| [symbol] Count actual coins dispensed | // improve UHMk-4 |

intelligence

| | |
|---|---|
| GOTO LOOP: | // Loop until all coins exit |

All coins exit correctly.

| | |
|---|---|
| Send TX_DATA_ACK (53h) to PC | // See UHMk-4 Driver |

```
  Datasheet
    // Note: Error condition or incorrect quantity of coins dispensed will be reported to PC in
    data portion of com. packet
  PC examines IMCI81 reply (opCode) for success (XENABLE_ACK) or error
  condition
  IF reply = error condition then handle Error
```

| | |
|---|---|
| ELSE continue with next operation (possibly DISPENSE_DATA) | // Dispense With Data |

------------------------------- END PSEUDO CODE ---------------------------------------------------------

The flow of control for one money handling peripheral device may be used to further illustrate the present invention. The flow of control for a JCM bill validator is discussed here. At some point in the user interface program, the general purpose computer will determine that the acceptance of paper currency is appropriate. At this point, the general purpose computer can send a status request message to the interface device. This status request message is sent to the bill validator, which, as previously described, is a virtual, generic, or general bill validator as it appears to the general purpose computer. In some embodiments, the status request message will be sent to the interface device port at which the bill validator is known to be coupled.

The interface device can then appropriately format or translate the status request message into a format appropriate for the particular model of bill validator. This command, which can be a bit vector for some parallel devices and a serial message stream for other bill validator devices, can then be sent or asserted to the physical bill validator at the given port. In response, the given bill validator will respond in a manner appropriate for that model of bill validator, or fail to respond within a timeout period.

If the response is abnormal or absent, indicating a fault condition, fault handling logic can be executed. If the response indicates that the bill validator is enabled or disabled, the general purpose computer can send a “change to enable” command. This command is translated into a format appropriate for the appropriate model of bill validator, and sent to the physical bill validator. In response, the bill validator will either reply with a fault message, fail to reply within a timeout period, or reply that the bill validator is enabled with a XENABLE_ACK reply to the general purpose computer.

The user can then input a bill or paper currency into the bill validator. The bill validator then sends a message through the interface device to notify the general purpose computer. The general purpose computer can then inquire as to whether there is a valid bill in escrow. A valid bill in escrow means that a validated piece of paper currency is still held within the bill validator awaiting further instructions. The general purpose computer can reply with an ESCROW_DATA_ACK.

The general purpose computer can then decide whether to reject the bill and return it to the user or stack the bill, adding the recently accepted bill to the stack of previously accepted bills. If the general purpose computer logic indicates that stacking the bill is appropriate, the general purpose computer can send a STACK BILL command through the interface device to the bill validator. The bill validator can then indicate whether a bill was successfully stacked or if there is a fault condition. If there is a fault condition, appropriate error handling logic can be executed. If the bill was successfully stacked, this message can be passed to the general purpose computer which can then execute the appropriate accounting software logic, for example, crediting the user with the successful input of money.

In another use of the invention, the money handling appliance can be used to pay utility or cellular telephone bills through deposit of money. In such an application, the user can walk up to the money handling appliance, and may be shown a “touch me” welcome screen on the general purpose computer display device. After the user initially interacts with the appliance, for example, by touching a region of the touch screen, a menu can appear, giving the user options. One such menu includes one option to inquire as to the current bill balance, while another option allows the user to pay the bill. The user can then enter an identification code, either by entering numbers and/or letters through the touch screen or by holding up a bill having a bar code to a bar code scanner.

The identification number or bar code number can be sent or transmitted to the utility company, through the modem, LAN, WAN, or other network connection previously described. If the money handling appliance fails to connect with the utility, appropriate error handling logic can be executed. If the connection is made, and the identification code is valid, the appropriate bill and/or coin validators can be enabled and any accounting totals set to zero and other initialization logic executed.

In some embodiments, the general purpose computer display screen will display the account data, the amount due, the total amount received so far, and a partial payment option button. Using logic previously described, the bill and/or coin validators can receive any money input by the user, reporting the successful input of money to the general purpose computer. The general purpose computer can maintain a running total of the monies successfully deposited during this session. After the user stops depositing any additional monies and/or the user indicates that he is finished depositing monies, the money total so far deposited can be transmitted to the utility company. The general purpose computer can then generate the appropriate “thank you” display and instruct the printer to print out a receipt.

Similar logic can be used for the retail store, petrol station, or intelligent deposit appliance embodiments of the present invention. In some of these embodiments, however, the money handling appliance may not communicate with any central host computer, but may rather store the data internally and await emptying of both money and data by the appropriate authorized personnel, for example, an armored car company guard.

1. A money handling kiosk device comprising:
a general purpose computer having a computer data communications port;
an interface device adapted to execute a computer program and having a primary data communications port for communicating with the general purpose computer data communications port and coupled to the general purpose data communications port,
wherein the interface device has at least one secondary port for communicating with a money handling peripheral device;
a money handling peripheral device coupled for data communication to the interface device secondary data communication port; and
an enclosure disposed about the interface device and the money handling peripheral device,
wherein the interface device is adapted to communicate to a general purpose computer and the interface device is adapted to communicate with a plurality of different models of money handling peripheral devices of the same money handling peripheral device type.

2. A device as in claim 1, wherein the interface device includes a circuit board having a serial port for communicating with the money handling peripheral device.

3. A device as in claim 2, wherein the general purpose computer issues commands to the interface device to control different models of the same money handling peripheral device type, wherein the issued commands are the same format for each model within the same money handling peripheral device type; and
wherein the interface device sends data to the general purpose computer from the money handling peripheral devices, wherein the sent data has the same format for each model of the same money handling peripheral device type, such that the same general purpose computer commands are sent to accomplish the same function for different models of the same money handling peripheral device type.

4. A device as claim 3, further including a plurality of software modules adapted to be executed on the interface device, adapted to receive commands from the general purpose computer, and adapted to control a particular model of a money handling peripheral device type.

5. A device as in claim 4, wherein the software modules for more than one model of a single money handling peripheral device type reside on the general purpose computer at the same time, for downloading to the interface device.

6. A device as in claim 4, wherein the software modules for more than one model of a single money handling peripheral device type reside on the interface device at the same time.

7. A programmable interface device for interfacing between a general purpose computer and at least one money handling peripheral device, the interface device comprising;
at least one primary data communication port for communicating to and/or from the general purpose computer;
at least one secondary communication port for communicating to and/or from the money handling peripheral device;
a program storage memory for storing a computer program executable on the intelligent interface device;
a processor coupled to the program storage memory for executing the program;
wherein the primary and secondary communication ports are coupled to the processor,
wherein the program accepts commands from the primary communication port, transforms the commands to a format acceptable by the money handling peripheral device coupled to the secondary port, wherein the program further includes logic for receiving data from the money handling peripheral device and transforming the data into a format acceptable by the general purpose computer coupled to the primary port.

8. A device as in claim 7, further comprising means for decrypting encrypted messages received from the primary communication port.

9. A device as in claim 7, further comprising software executing on the interface device for communicating between the general purpose computer and at least one additional model of money handling peripheral device of the same type.

10. A device as in claim 7, wherein the program for accepting commands from the primary communication port accepts commands for a general money handling peripheral device type and transforms the commands to a format acceptable by a particular model of money handling peripheral device, wherein the program for receiving data from the particular model of money handling peripheral device transforms the data into a format representing the general money handling peripheral device type.

11. A money handling kiosk device comprising:
a user interface device for providing information to users and accepting commands from users, the user interface device including an information output portion and an information input portion, the user interface device including a communication port;
a programmable interface device coupled to the user interface device information communication port through a data communication port for accepting commands from the user interface device and reporting data to the user interface device; wherein the interface device has at least one money handling peripheral device communication port;
at least one money handling peripheral device for handling currency, being coupled to the intelligent interface device money handling peripheral device communication port for receiving commands from the intelligent interface device and transmitting data to the intelligent interface device; and
a tamper-resistant enclosure disposed about the money handling peripheral devices and interface device and having apertures therein for allowing access to the money handling peripheral devices,
wherein the interface device includes a processor for executing a program for receiving messages from the user interface device communication port and transforming the messages into commands for the money handling peripheral device, and wherein the interface device executes a program for receiving data from the money handling peripheral device and transforming the data into a data message for the user interface device.

12. A device as in claim 11, wherein the intelligent interface device includes a processor, a memory for storing a computer program, at least one serial communication port for communicating to the user interface device, at least one serial port for communicating to a serial money handling peripheral device, and at least one parallel communication port for communicating to a parallel port money handling peripheral device.

13. A device as in claim 11, wherein the user interface device is a general purpose computer including a display for sending information to the user.

14. A device as in claim 13, wherein the general purpose computer is coupled to a touch screen for accepting information from the user.

15. A device as in claim 11, wherein the user interface device includes a general purpose computer, wherein the general purpose computer includes resident software executable on the interface device for communicating to more than one model of money handling peripheral devices of the same type, wherein the types are selected from the group consisting of bill validators, coin validators, bill dispensers, and coin dispensers.

16. An intelligent money handling appliance, the appliance comprising:
an interface device having a processor;
a general purpose computer coupled to the interface device, the interface device in turn coupled to at least two money handling peripheral devices, wherein the general purpose computer includes software downloadable to the interface device and executable on the interface device, wherein the software includes more than one module for talking to different models of money handling peripheral devices of the same type.

17. A device as in claim 16, wherein the appliance includes at least two software modules executable on the interface device for talking to different models of bill validators.

18. A device as in claim 16, wherein the software includes at least two software modules, each capable of executing on the interface device and adapted to communicate to the different models each capable of communicating to the general purpose to the general purpose computer in the same format for different models of the same type.

19. A device as in claim 16, wherein the more than one modules are stored on the general purpose computer.

20. A device as in claim 16, wherein the more than one modules are stored on the general purpose computer.

21. A money handling appliance comprising:
a programmable interface device having a processor;
a general purpose computer coupled to the interface device, the interface device in turn coupled to at least two money handling peripheral devices, wherein the general purpose computer includes software downloadable to the interface device and executable on the interface device, wherein the software includes a different module for talking to different models of money handling peripheral devices of the same type,
wherein the interface device executes a first software portion adapted to receive commands from the general purpose computer and issue money handling peripheral device commands to the money handling peripheral device, wherein the interface device executes a second software portion adapted to receive data from the money handling peripheral device and send the data received from the money handling peripheral device to the general purpose computer, wherein the software module first portions are adapted to receive the same commands for different models of the same type of money handling peripheral device, and wherein the first and second software portions are adapted to send the same data format to the general purpose computer for each model of money handling peripheral device of the same type.

22. A kit comprising:
an interface printed circuit board;
at least one primary data communication port for communicating to and from the general purpose computer;
at least one secondary communication port for communicating to and from the money handling peripheral device;
a program storage memory for storing a computer program executable on the intelligent interface device;
a processor coupled to the program storage memory for executing the program;
wherein the primary and secondary communication ports are coupled to the processor,
wherein the program accepts commands from the primary communication port, transforms the commands to a format acceptable by the money handling peripheral device coupled to the secondary port, wherein the program further includes logic for receiving data from the money handling peripheral device, and transforming the data into a format acceptable by the general purpose computer coupled to the primary port; and
software loadable onto the intelligent circuit board and executable on the interface circuit board, where in the software includes more than one software module for interfacing between the general purpose computer and money handling peripheral devices of the same type.

23. A kit as in claim 22, where the money handling peripheral devices are selected from the group consisting of bill validators, coin validators, bill dispensers, and coin dispensers.

24. A kit as in claim 22, wherein the kit includes software modules for communicating to different money handling peripheral bill validator device models, wherein each software module can accept identical commands from the general purpose computer and transform the commands into money handling peripheral device commands specific to the money handling peripheral device model.

25. A kit as in claim 23, wherein the software includes more than one software module for reporting data from different model money handling peripheral devices of the same type, wherein the different software modules for each model each transform the data received from the money handling peripheral devices into a common format to be received by the general purpose computer.

26. A software system comprising:
a plurality of software modules each adapted to receive a common command set and to control different models of money handling peripheral devices of the same type, wherein the software modules are each adapted to run on the same interface device board coupled to the type of money handling peripheral device to be controlled.

27. A software system as in claim 26, wherein each software module is adapted to be executed on the same interface device processor board and is adapted to communicate with a different model of money handling peripheral device of the same type, where each of the software modules sends data messages in a common format for the common money handling peripheral device type, such that the general purpose computer is not required to be aware of the particular money handling peripheral device model to interpret the data received.

28. One or more computer-readable media storing computer-executable instructions for a plurality of software modules each adapted to receive a common command set and to control different models of money handling peripheral devices of the same type, wherein the software modules are each adapted to run on the same interface device board coupled to the type of money handling peripheral device to be controlled.

29. A computer-readable media as in claim 28, wherein each software module is adapted to be executed on the same interface device processor board and is adapted to communicate with a different model of money handling peripheral device of the same type, where each of the software modules sends data messages in a common format for the common money handling peripheral device type, such that the general purpose computer is not required to be aware of the particular money handling peripheral device model to interpret the data received.
